(19) United States
(12) Patent Application Publication
(10) Pub. No.: US 2006/0203884 A1
(43) Pub. Date: Sep. 14, 2006

(54) Adaptable probe assembly for a measuring instrument

(76) Inventor: Brian Sundberg, Chester, NH (US)

Correspondence Address: IP STRATEGIES, 12 1/2 WALL STREET, SUITE I, ASHEVILLE, NC, 28801, US

(21) Appl. No.: 11/207,617

(22) Filed: Aug. 19, 2005

Related U.S. Application Data
(60) Provisional application No. 60/660,810, filed on Mar. 11, 2005.

(51) Int. Cl. G01K 7/00; G01K 1/00

(52) U.S. Cl. 374/208; 374/163

(57) ABSTRACT

An adaptable probe assembly for a measuring instrument includes a probe module and a plurality of probe ends. The probe module is adapted to provide a parameter value signal to a base unit of the measuring instrument. Each of the probe ends is adapted to be removably communicatively connected to the probe module such that a parameter measurement taken by the probe end is provided to the base unit as the corresponding parameter value signal.

### CROSS-REFERENCE TO RELATED APPLICATION

This is related to and claims priority from U.S. Provisional Patent Application Ser. No. 60/660,810, which was filed on Mar. 11, 2005.

### BACKGROUND OF THE INVENTION

Many measuring instruments detect and measure a parameter through the use of a probe designed to sense the parameter in an area of interest. The probe usually incorporates a functional design for accurate sensing of the parameter, as well as a physical design adapted to the area of interest. Often, the physical design of the probe enhances the capability for accurate measurement.

In some cases, different types of areas of interest are intended to be measured using the same instrument. However, differences in the physical dimensions and proportions of the areas of interest lead to differences in measurement accuracy if a single probe is used in each case. It is typical to provide a probe that is somewhat adaptable under all contemplated physical conditions. According to this solution, it is known that a certain degree of accuracy will be compromised in order to provide this adaptability. If more accuracy is required, specialty instruments having probes suitable for particular areas of interest can be provided. Such devices will provide better accuracy in measurement, but are an expensive solution if different types of measurement will be made.

It would be advantageous to provide a single measuring instrument that is adaptable to areas of interest having a variety of physical dimensions.

### BRIEF DESCRIPTION OF THE INVENTION

According to an aspect of the invention, an adaptable probe assembly for a measuring instrument includes a probe module and a number of probe ends. The probe module is adapted to provide a parameter value signal to a base unit of the measuring instrument. Each of the probe ends is adapted to be attached or otherwise communicatively connected to the probe module such that a parameter measurement taken by the probe end is provided to the base unit as the corresponding parameter value signal. For example, each probe end can be adapted to be removably communicatively connected to the probe module. Alternatively, each probe end can be fixedly connected to the probe module, such that all probe ends are available for parameter measurements at any time.

Each probe end can include a measurement device that measures a predetermined parameter at a location of interest. The probe end can convert the parameter measurement to the parameter value signal. Alternatively, the probe end can pass the parameter measurement to the probe module and the probe module can convert the parameter measurement to the parameter value signal. Conversion can include buffering, scaling, and/or modulating the parameter measurement.

Each probe end can be shaped to measure the parameter in a different physical setting.

For example, each probe end can include a temperature measurement device that measures temperature at a location of interest, in which case the parameter value signal is a temperature signal. The probe end can convert the temperature measurement to the temperature signal. Alternatively, the probe end can pass the temperature measurement to the probe module and the probe module can convert the temperature measurement to the temperature signal. Each probe end can be shaped to measure the temperature in a different physical location of a human body. For example, the probe ends can include probe ends adapted to measure temperature at any two or more locations such as under the tongue, under the armpit, and in the rectum.

According to another aspect of the invention, a measuring instrument includes a base unit and an adaptable probe assembly as described above. The measuring instrument can also include a display device on which a visual representation of the measured parameter is presented, such as a numeric representation. For example, the base unit can include a display device on which a visual representation of the measured parameter is presented, such as a numeric representation. The base unit can be fabricated as a separate assembly from the probe module, or the base unit and the probe assembly can be fabricated in a single enclosure. The base unit can include at least one receptacle that is adapted to store at least one of the probe ends.

For example, a thermometer can include a base unit and an adaptable probe assembly as described above. The thermometer can include a display device on which a visual representation of the measured temperature is presented, such as a numeric representation. For example, the base unit can include a display device on which a visual representation of the measured temperature is presented, such as a numeric representation.

According to another aspect of the invention, a measuring instrument includes a base unit and an adaptable probe assembly. The adaptable probe assembly includes a plurality of probes. Each probe is adapted to be communicatively connected to the base unit such that a parameter measurement taken by the probe is provided to the base unit as a corresponding parameter value signal. For example, each probe can be adapted to be removably communicatively connected to the base unit. Alternatively, each probe can be fixedly connected to the base unit, such that all probes are available for parameter measurements at any time. In particular embodiments, each probe can include a temperature measurement device that measures temperature at a location of interest, in which case the parameter value signal is a temperature signal.

### BRIEF DESCRIPTION OF THE DRAWINGS

FIG. 1 is a block diagram of an adaptable probe assembly and measuring instrument of the present invention.

FIG. 2 is an illustration of an exemplary thermometer base unit.

FIG. 3 is an illustration of an exemplary thermometer including an exemplary adaptable probe assembly.

FIG. 4 is an illustration of an exemplary thermometer including an exemplary adaptable probe assembly.

FIG. 5 is an illustration of an exemplary thermometer including an exemplary adaptable probe assembly.

FIG. 6 is an illustration of an exemplary probe end.

FIG. 7 is an illustration of an exemplary probe end.

FIG. 8 is an illustration of an exemplary probe end.

FIG. 9 is an illustration of an exemplary base unit of a measuring instrument including an adaptable probe assembly, including storage for multiple probe ends.

### DETAILED DESCRIPTION OF THE INVENTION

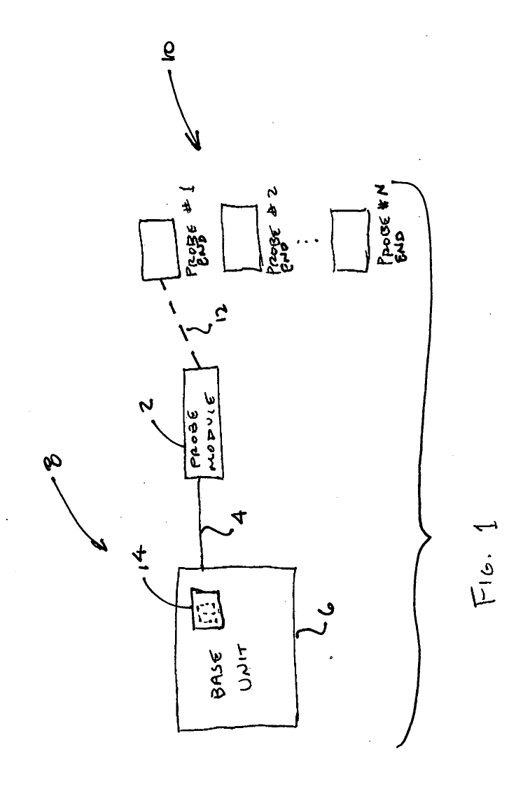

As shown in FIG. 1, a probe module 2 is adapted to provide a parameter value signal 4 to a base unit 6 of a measuring instrument 8. The probe module 2 is shown connected to the base unit 6, preferably removably connected. However, the base unit 6 and the probe module 2 can be wirelessly connected, such as by RF or IR link, or connected in a fixed fashion. Also shown are a number of probe ends 10. Each of the probe ends 10 is adapted to be coupled, preferably removably, to the probe module 2 such that a parameter measurement 12 taken by the probe end 10 is provided to the base unit 6 as the parameter value signal 4. Thus, a probe end 10 is selected for connection for communication with the probe module 2 (directly or remotely), and the selected probe end 10 is used to measure a predetermined parameter at a location of interest, through the use of a parameter measurement device that is included as part of the probe end 10. This parameter measurement 12 is provided to the base unit 6 as a parameter value signal 4, through conversion and processing by the probe end 10, the probe module 2, the base unit 6, or some combination of the three elements or by an intervening element.

In embodiments having probe ends that are fixedly connected to the probe module, each probe end is available to take a measurement at any time, and either the probe module or the base unit, or both, detects which probe end is being used and interprets the measurement signal accordingly. In this type of embodiment, the probe module can be incorporated into the base unit, or can be eliminated, in which case the base unit provides the probe module functionality. Similarly, the probe module functionality can be incorporated into the base unit even in embodiments in which the probe ends are removably connected, although it is preferable in those embodiments that the probe module be provided as a separate component, to allow measuring distance from the base unit without the need to provide multiple cables.

Multiple probe ends 10 are provided to allow for flexibility in measuring the predetermined parameter. For example, each probe end 10 can be shaped to measure the parameter in a different physical setting, depending on the location of interest. If proximity is an issue in the accuracy of a parameter measurement, probe ends having different shapes can be useful depending on the physical constraints of the measurement location, and a probe end selection can be made accordingly. Alternatively, the base unit 6 of the measuring device can be designed to accept measurements of different parameters, depending on the probe end 10 selected. In this case, a first probe end might be used to measure a first parameter, a second probe end to measure a second parameter, and so on. The base unit 6 will sense and identify the connected probe end 10 and receive and process the parameter measurement 12 or parameter value signal 4 accordingly. Thus, the different probe ends 10 are provided to allow for measurements to be taken using a single base unit 6 under different physical or functional situations.

The measuring instrument 8 can also include a display device 14 on which a visual representation of the measured parameter is presented. The display device 14 can be integrated into the base unit 6, as shown, or it can be connected to the base unit 6, directly or remotely, as a separate component or integrated into another component. The display device 14 can provide a numerical indication of the measured parameter value 12, and can also include an indication of the units of measurement for the displayed value. If the measuring instrument 8 is designed for multiple-parameter use, an indication of the measured parameter is preferably included on the display device 14 as well. The display device 14 can provide a visual or audible indication that the measured parameter has exceeded a pre-set threshold, either in addition to or instead of the numerical indication.

### Exemplary Embodiments

For ease of explanation, an exemplary embodiment adapted for measuring temperature is described below. The present invention is not limited to this exemplary embodiment, and includes any type of measuring instrument.

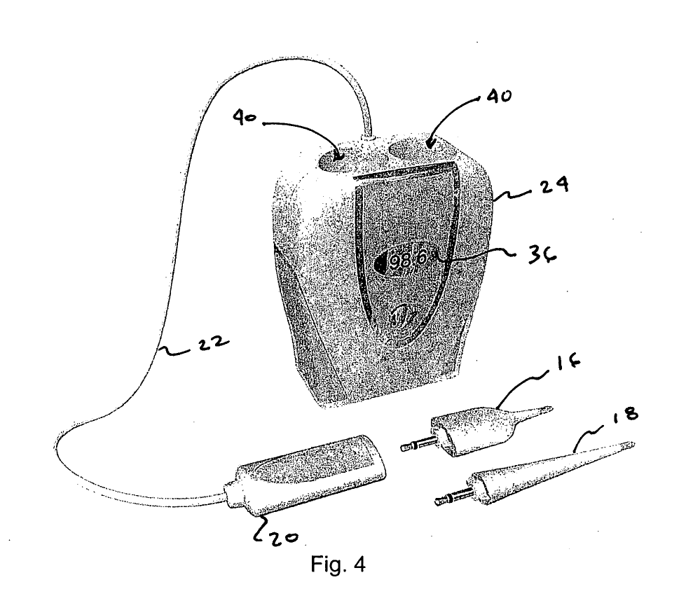

As shown in FIG. 4, two probe ends 16, 18 are available for use with the probe module 20. Each probe end has a first end that is adapted to connect communicatively with the probe module 20, and a second end that is adapted to take a temperature measurement. It is contemplated that the second end of the probe end is connected to conventional circuitry for measuring temperature, such as that including a transducer or the like.

Preferably, the probe ends 16, 18 and the probe module 20 are fitted with standard connectors for attachment. For example, the probe ends 16, 18 shown are fitted with male RCA-type connectors, and the probe module 20 is fitted with a corresponding RCA plug. The probe module 20 can be constructed merely to provide an interface to pass the signal from the probe end to the electrical cable 22. Alternatively, the probe module 20 can provide signal buffering or other functionality prior to passing the signal. The electrical cable 22 can be any type that is suitable for communicating the signal reliably from the probe module 20 to the base unit 24.

As shown, the first probe end 16 and the second probe end 18 have different shapes, so as to facilitate temperature measurement at different locations of the body. The first probe end 16 shown is shaped to provide particular advantage for rectal temperature measurements, and the second probe end 18 is shaped particularly for use with sub-lingual measurements, although these intended uses do not preclude use of the probe ends at other locations.

FIG. 3 shows the probe module 20 with the first probe end 16 connected. When the first probe end 16 is used to measure the temperature at the location of interest, the measured temperature value is passed to the probe end 16, either directly, buffered, or as converted to a temperature signal for use by the base unit 24.

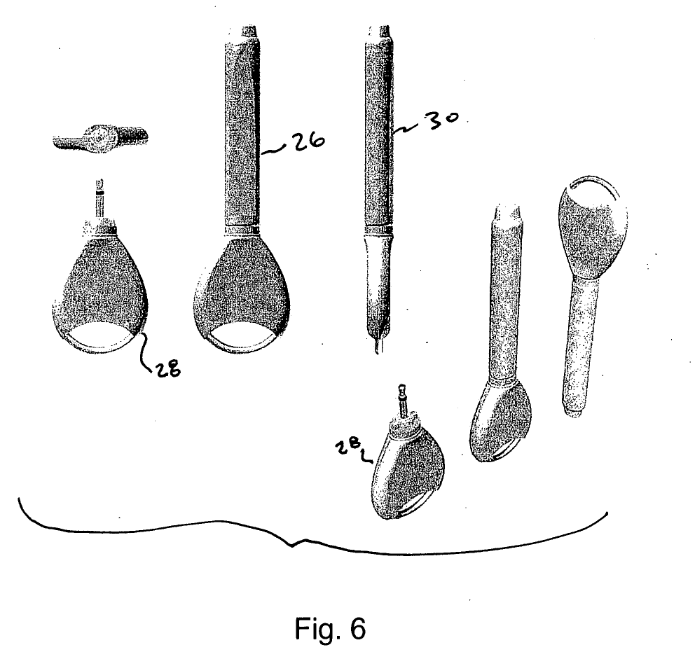

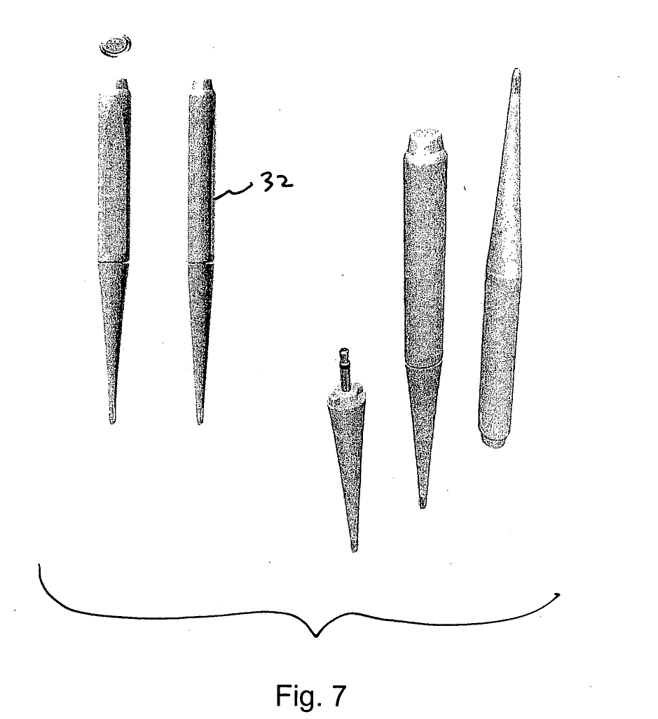

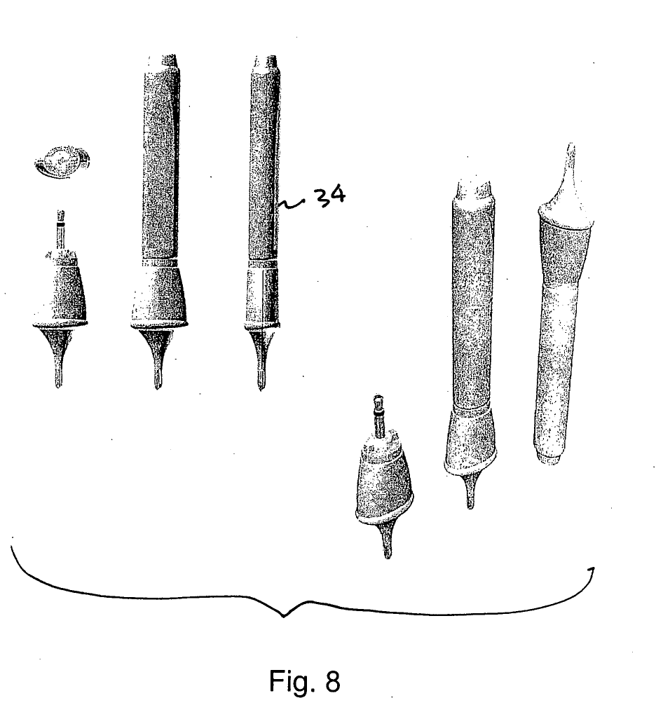

FIG. 6 shows different views of an exemplary probe end 26, designed to be used for particular advantage as an underarm probe. Thus, this probe end 26 is particularly intended to be placed in the closed armpit of the subject for measurement of body temperature. As shown, this probe end 26 can be provided as a two-piece component, such that the first piece 28 determines the temperature measurement and the second piece 30 acts as an extender to pass the measurement from the first piece 28 to the probe module 20. FIG. 7 shows different views of an exemplary sub-lingual probe end 32 and FIG. 8 shows different views of an exemplary rectal probe end 34. As shown, these exemplary probe ends also can be fabricated as multiple-piece components. Other probe ends, such as those adapted for measuring temperature in an ear, can be provided and are contemplated for use as part of the present invention.

In a preferred embodiment, either the base unit 24 or the probe module 20 includes means for determining which probe end is connected to the probe module 20, and for communicating that information to the temperature-determining circuitry so that the proper algorithm can be applied to convert the temperature signal to the value displayed at the base unit 24. If the thermometer is the type that uses a predictive algorithm to estimate the temperature, the particular detected probe end could affect this algorithm as well.

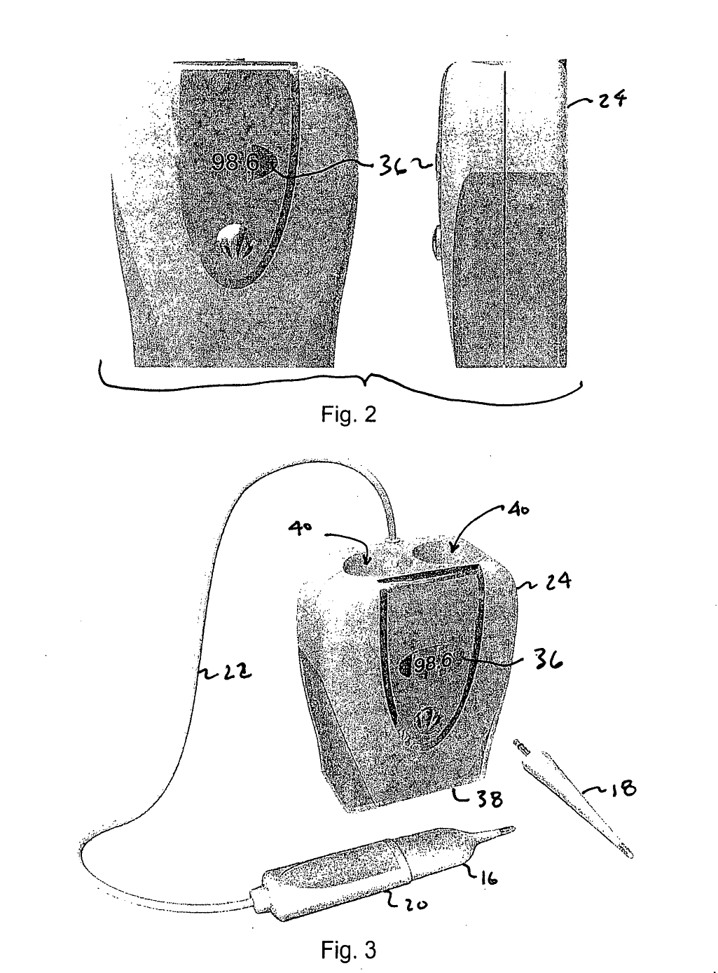

FIG. 2 shows two views of an exemplary base unit 24 for a measuring instrument to be used with the probe assembly, in this case the base unit 24 for a thermometer. As shown, the base unit 24 includes a display 36, such as an LCD display, that presents a numerical value indicating the value of the measured temperature. Preferably, the base unit 24 has a flat bottom surface 38 to allow the base unit 24 to stand in a stable position on a table or other flat surface. FIGS. 3 and 4 show the base unit 24 connected to the probe module 20 by a cable 22, for transmitting the measured temperature value or the temperature signal from the probe module 20 to the base unit 24. The temperature signal is processed by the base unit 24 to cause the display 36 to present the numerical value indicating the value of the measured temperature.

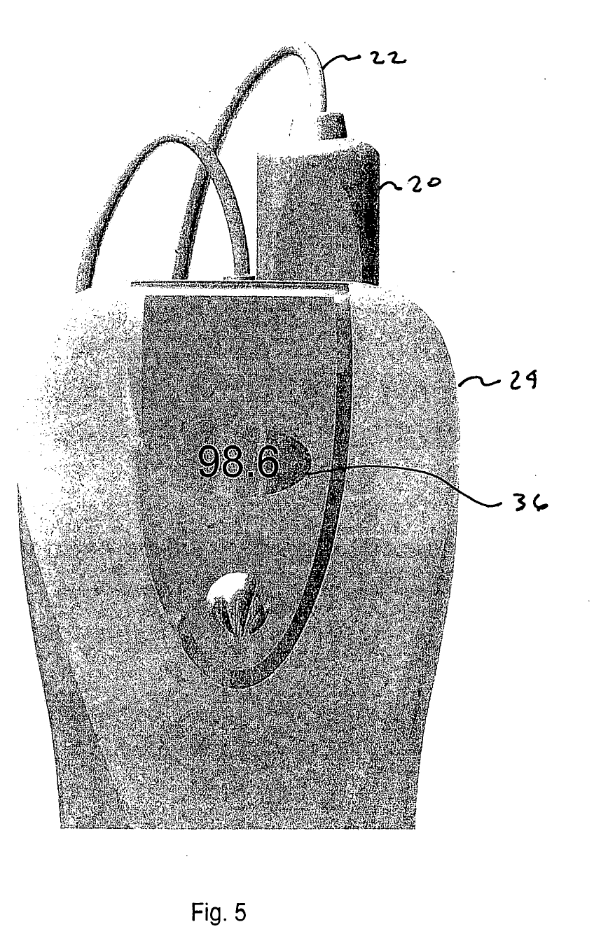

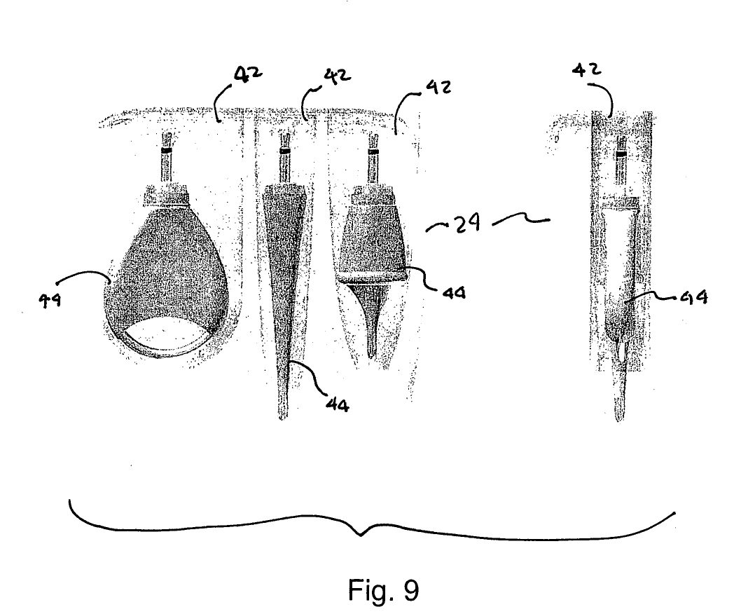

As shown in FIGS. 3 and 4, the exemplary base unit 24 includes receptacles 40 for storing the probe ends. The receptacles 40 can be used to store the probe end that is not connected, or, as shown in FIG. 5, also for storing the probe end that is connected to the probe module. FIGS. 3 and 4 show two receptacles 40, for use with a thermometer that includes two probe ends. However, more receptacles can be provided to accommodate the provided number of probe ends. For example, FIG. 9 shows a base unit 24 with three receptacles 42, storing three probe ends 44. As shown, each receptacle 42 is particularly shaped to accommodate a corresponding one of the probe ends 44.

Particular exemplary embodiments of the present invention have been described in detail. These exemplary embodiments are illustrative of the inventive concept recited in the appended claims, and are not limiting of the scope or spirit of the present invention as contemplated by the inventors.

I claim:

1. An adaptable probe assembly for a measuring instrument, comprising:
a probe module that is adapted to provide a parameter value signal to a base unit of the measuring instrument; and
a plurality of probe ends, wherein each said probe end is adapted to be communicatively connected to the probe module such that a parameter measurement taken by the probe end is provided to the base unit as the corresponding parameter value signal.

2. The adaptable probe assembly of claim 1, wherein each said probe end is adapted to be removably communicatively connected to the probe module.

3. The adaptable probe assembly of claim 1, wherein each said probe end is fixedly connected to the probe module.

4. The adaptable probe assembly of claim 1, wherein each said probe end includes a measurement device that measures a predetermined parameter at a location of interest.

5. The adaptable probe assembly of claim 4, wherein the probe end converts the parameter measurement to the parameter value signal.

6. The adaptable probe assembly of claim 5, wherein the probe end converts the parameter measurement by at least one of buffering, scaling, and modulating the parameter measurement.

7. The adaptable probe assembly of claim 4, wherein the probe end passes the parameter measurement to the probe module.

8. The adaptable probe assembly of claim 7, wherein the probe module converts the parameter measurement to the parameter value signal.

9. The adaptable probe assembly of claim 8, wherein the probe module converts the parameter measurement by at least one of buffering, scaling, and modulating the parameter measurement.

10. The adaptable probe assembly of claim 1, wherein each of the plurality of probe ends is shaped to measure the parameter in a different physical setting.

11. The adaptable probe assembly of claim 1, wherein each said probe end includes a temperature measurement device that measures temperature at a location of interest, and wherein the parameter value signal is a temperature signal.

12. The adaptable probe assembly of claim 11, wherein the probe end converts the temperature measurement to the temperature signal.

13. The adaptable probe assembly of claim 11, wherein the probe end passes the temperature measurement to the probe module.

14. The adaptable probe assembly of claim 13, wherein the probe module converts the temperature measurement to the temperature signal.

15. The adaptable probe assembly of claim 11, wherein each of the plurality of probe ends is shaped to measure the temperature in a different physical location of a human body.

16. The adaptable probe assembly of claim 15, wherein the plurality of probe ends includes probe ends adapted to measure temperature at at least any two locations selected from the group consisting of under the tongue, under the armpit, and in the rectum.

17. A measuring instrument, comprising:
the base unit; and
the adaptable probe assembly of claim 1.

18. The measuring instrument of claim 17, wherein the base unit and the probe module are disposed within a single enclosure.

19. The measuring instrument of claim 17, wherein the base unit includes at least one receptacle that is adapted to store at least one said probe end.

20. The measuring instrument of claim 17, further comprising a display device on which a visual representation of the measured parameter is presented.

21. The measuring instrument of claim 20, wherein the visual representation is a numeric representation.

22. The measuring instrument of claim 17, wherein the base unit includes a display device on which a visual representation of the measured parameter is presented.

23. The measuring instrument of claim 22, wherein the visual representation is a numeric representation.

24. A thermometer, comprising:
the base unit; and
the adaptable probe assembly of claim 11.

25. The thermometer of claim 24, further comprising a display device on which a visual representation of the measured temperature is presented.

26. The measuring instrument of claim 25, wherein the visual representation is a numeric representation.

27. The thermometer of claim 24, wherein the base unit includes a display device on which a visual representation of the measured temperature is presented.

28. The measuring instrument of claim 27, wherein the visual representation is a numeric representation.

29. A measuring instrument, comprising:
a base unit; and
an adaptable probe assembly, wherein the adaptable probe assembly includes a plurality of probes, wherein each said probe is adapted to be communicatively connected to the base unit such that a parameter measurement taken by the probe is provided to the base unit as a corresponding parameter value signal.

30. The measuring instrument of claim 29, wherein each said probe is adapted to be removably communicatively connected to the base unit.

31. The measuring instrument of claim 29, wherein each said probe is fixedly connected to the base unit.

32. The measuring instrument of claim 29, wherein each said probe includes a temperature measurement device that measures temperature at a location of interest, and wherein the parameter value signal is a temperature signal.
